(19) United States
(12) Patent Application Publication
(10) Pub. No.: US 2003/0122518 A1
(43) Pub. Date: Jul. 3, 2003

(54) Electrical motor-driven lathe

(76) Inventor: Lu-Hsiung Chang, Taichung Hsien (TW)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 10/270,462

(22) Filed: Oct. 15, 2002

(30) Foreign Application Priority Data
Dec. 31, 2001 (TW) 090224307

(51) Int. Cl. G05B 11/32

(52) U.S. Cl. 318/625

(57) ABSTRACT

An electrical motor-driven lathe includes a work spindle mounted in and rotatable relative to a headstock about a first axis. A compound slide is mounted to be movable along a guideway that extends in a longitudinal direction parallel to the first axis. A feed shaft is mounted to be rotatable relative to the headstock about a second axis parallel to the first axis, and is coupled to the compound slide to transmit a predetermined rotational force to the compound slide so as to move the compound slide along the guideway to a predetermined position. A first servomotor is disposed to drive the work spindle to rotate about the first axis at a predetermined velocity. A second servomotor is disposed to deliver the predetermined rotational force to the feed shaft. A controller is disposed to control the first and second servomotors.

### CROSS-REFERENCE TO RELATED APPLICATION

This application claims priority of Taiwanese Application No. 090224307, filed on Dec. 31, 2001.

### BACKGROUND OF THE INVENTION

1. Field of the Invention

The invention relates to a lathe, more particularly to an electrical motor-driven thread cutting lathe that eliminates the use of a gearbox, that is not of the computer numerical control (CNC) type, and that is simple in construction and easy to operate.

2. Description of the Related Art

Referring to FIG. 1, a conventional lathe which is not of the computer numeric control type essentially includes a workbench 100 that has a headstock 1 and a tailstock 102 mounted at opposite ends thereof, and a guiding mechanism 2 and a compound slide 3 mounted thereon. The headstock 1 has a work spindle 101 mounted rotatably therein for rotating a workpiece (not shown) that is held between the headstock 1 and the tailstock 102. The guiding mechanism 2 includes a feed shaft 201 and a gearbox 202. The feed shaft 201 is disposed in parallel to and below the work spindle 101. The gearbox 202 is mounted at one end of the workbench 100 adjacent to the headstock 101 and the feed shaft 201. A gear set within the gearbox 202 transmits power to drive the work spindle 101 and the feed shaft 201 to rotate synchronously. The gearbox 202 has an adjusting rod 203 mounted thereon, which is operable to change meshing relationship of the gear set so as to adjust the velocity ratio between the work spindle 101 and the feed shaft 201. The compound slide 3 is mounted to be slidably movable along a guideway 103 that extends between the headstock 1 and the tailstock 102. The compound slide 3 is coupled to the feed shaft 201, which transmits a rotational force from the gearbox 202 to the compound slide 3 to cause the latter to slide along the guideway 103, and which has a tool holding post disposed thereon for mounting a cutting tool (not shown). In a thread cutting operation, when a workpiece (not shown) is held by a gripping member of the work spindle 101 and is rotated therewith, the feed shaft 201 will be brought to rotate synchronously with the work spindle 101 via the gearbox 202 so that the compound slide 3 moves slidably and longitudinally along the guideway 103 to cut threads in the workpiece (not shown) using the cutting tool. When it is desired to adjust the pitch of the threads to be cut, it is necessary to manipulate the adjusting rod 203 to change the meshing relationship of the gear set so as to change the velocity ratio between the work spindle 101 and the feed shaft 201. However, such a lathe is complicated in construction, and does not permit easy maintenance. Besides, as the velocity ratio between the spindle 101 and the feed shaft 201 is dictated by the meshing relationship of the gear set, the speed change of the spindle 101 and the feed shaft 201 is of a stepped type, i.e., there are a limited number of velocity ratios available. This means that the lathe is capable of cutting threads of pitches of fixed dimensions. Moreover, a larger number of gears are required to permit thread cutting in more steps.

FIG. 2 shows a conventional lathe of another design, which is substantially similar to the aforesaid conventional lathe in construction and operation, and which likewise includes a headstock 4 having a work spindle 401 mounted therein, a tailstock 402 mounted opposite to the headstock 4, a guiding mechanism 5 including a gearbox 502 and a feed shaft 501, and a compound slide 6.

### SUMMARY OF THE INVENTION

Therefore, the main object of the present invention is to provide an electrical motor-driven lathe that is simple in construction and convenient to maintain, and that is capable of stepless thread cutting without the use of a gearbox.

Accordingly, an electrical motor-driven lathe of this invention includes:

a headstock;

a work spindle mounted in and rotatable relative to the headstock about a first axis, the work spindle being adapted for mounting a gripping member to hold a workpiece;

a guideway disposed to extend in a longitudinal direction parallel to the first axis;

a compound slide mounted to be movable along the guideway, and adapted to carry a tool holding post thereon;

a feed shaft mounted to be rotatable relative to the headstock about a second axis parallel to the first axis, and coupled to the compound slide to transmit a predetermined rotational force to the compound slide so as to move the compound slide along the guideway to a predetermined position;

a first servomotor disposed to drive the work spindle to rotate about the first axis at a predetermined velocity;

a second servomotor disposed to deliver the predetermined rotational force to the feed shaft, the second servomotor being independent of the first servomotor in mechanical drive; and

a controller disposed to control the first and second servomotors to drive the work spindle and to deliver the predetermined rotational force, respectively.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic perspective view of a conventional thread cutting lathe;

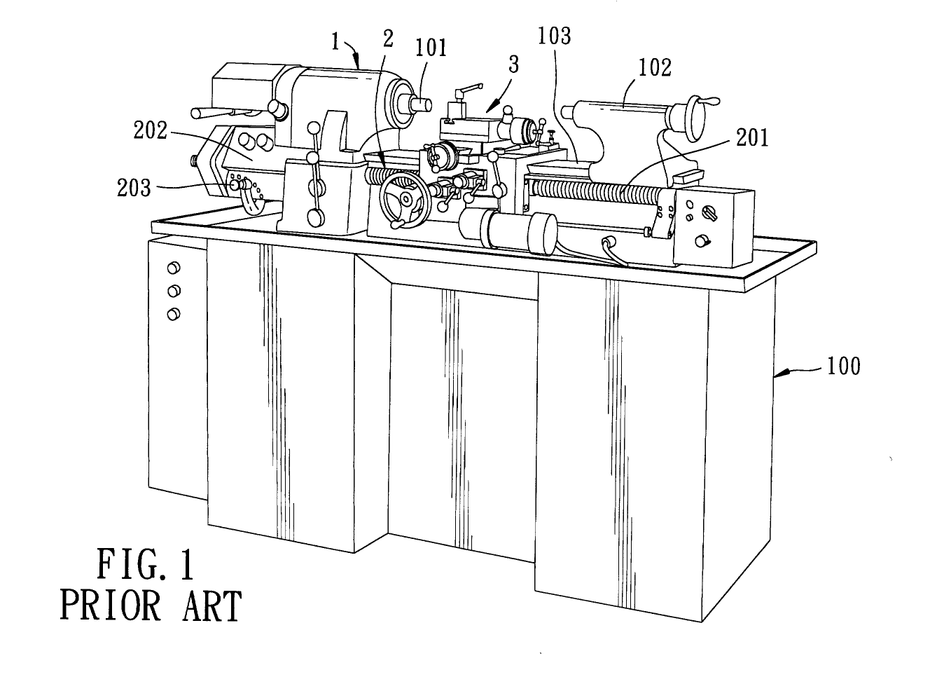

FIG. 2 is a schematic perspective view of another conventional thread cutting lathe;

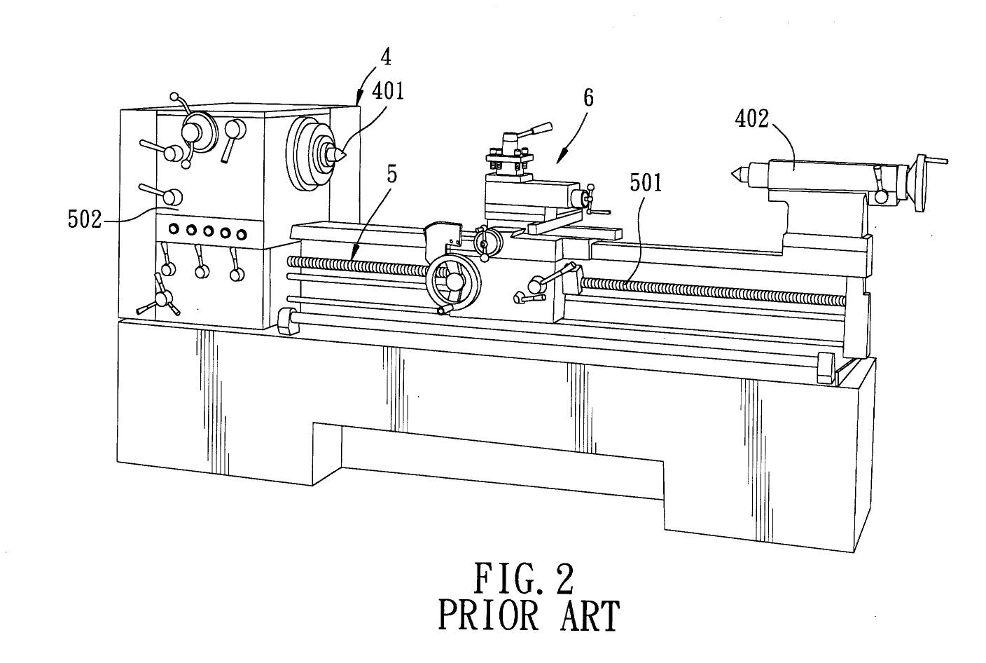

FIG. 3 is a perspective view of the preferred embodiment of an electrical motor-driven lathe according to the present invention; and

FIG. 4 is a perspective view of an alternative embodiment of the electrical motor-driven lathe of the present invention.

### DETAILED DESCRIPTION OF THE PREFERRED EMBODIMENTS

Before the present invention is described in greater detail, it should be noted that like elements are denoted by, the same reference numerals throughout the disclosure.

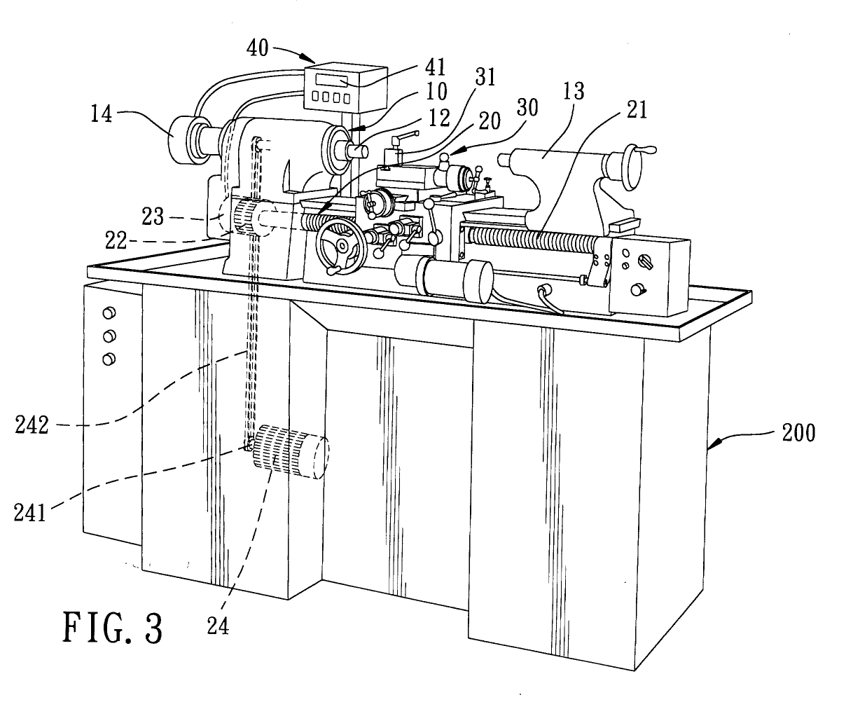

Referring to FIG. 3, the first preferred embodiment of an electrical motor-driven lathe according to the present invention is shown to include a workbench 200, a headstock 10, a tailstock 13, a guiding mechanism 20, a compound slide 30, and a controller 40 mounted on the workbench 200.

A work spindle 12 is mounted in and is rotatable relative to the headstock 10 about a first axis that is parallel to the longitudinal direction. The work spindle 12 is adapted for mounting a gripping member (not shown) for co-rotation with the work spindle 12 and for holding a workpiece (not shown) so as to impart rotational movement of the work spindle 12 to the workpiece. The tailstock 13 is mounted opposite to the headstock 10 in a longitudinal direction, and is movable so as to be clamped in any desired position and to cooperate with the headstock 10 for holding the workpiece therebetween during a thread cutting operation. A feed shaft 21 is mounted to be rotatable relative to the headstock 10 about a second axis that is parallel to the first axis.

The compound slide 30 is mounted straddlingly on the workbench 200, and is movable along a guideway that extends in the longitudinal direction between the headstock 10 and the tailstock 13. The feed shaft 21 extends through the compound slide 30, and is coupled to the compound slide 30 so as to transmit a predetermined rotational force to the compound slide 30 to thereby move the compound slide 30 along the guideway to a predetermined position. The compound slide 30 is adapted to carry a tool holding post 31 thereon for mounting a cutting tool (not shown) for cutting the workpiece (not shown).

A first servomotor 24 is disposed to drive the work spindle 12 to rotate about the first axis at a predetermined velocity, and is associated with a first encoder 14 mounted at a rear end of the work spindle 12 for rotation encoding. In this embodiment, the first servomotor 24 is provided with an output shaft 241 to deliver a predetermined drive, and is disposed to have the output shaft 241 oriented in a line parallel to the first axis. A transmission belt 242 is further provided to transmit the predetermined drive to the work spindle 12 to drive the work spindle 12 to rotate at the predetermined velocity.

A second servomotor 22, which is independent of the first servomotor 24 in terms of mechanical drive, is mounted at one end of the feed shaft 21 to deliver the predetermined rotational force to the feed shaft 21 so as to rotate the feed shaft 21, and is associated with a second encoder 23 mounted at a rear end of the second servomotor 22 for rotation encoding.

The controller 40 is coupled electrically to the first encoder 14 and the first servomotor 24, and controls velocity of the first servomotor 24 so as to drive the work spindle 12 to rotate at the predetermined velocity. The controller 40 is also coupled electrically to the second encoder 23 and the second servomotor 22, and controls velocity of the second servomotor 22 so as to control the second servomotor 22 to deliver the predetermined rotational force to the feed shaft 21. The controller 40 is adapted for input of numerical data, receives outputs of the first and second encoders 14, 23, and controls velocities of the work spindle 12 and the feed shaft 21 according to the input numerical data and the encoder outputs. The controller 40 further includes a screen 41 for displaying the velocities of the work spindle 12 and the feed shaft 21.

In use, a desired pitch value is inputted via the controller 40, which then controls the velocities of the work spindle 12 and the feed shaft 21 with reference to outputs of the first and second encoders 14, 23 so as to rotate the workpiece and to advance the compound slide 30 to perform a thread cutting operation on the workpiece. If it is desired to vary the pitch of the threads to be cut, it is merely necessary to input corresponding numerical data via the controller 40 so as to change the velocities of the work spindle 12 and the feed shaft 21.

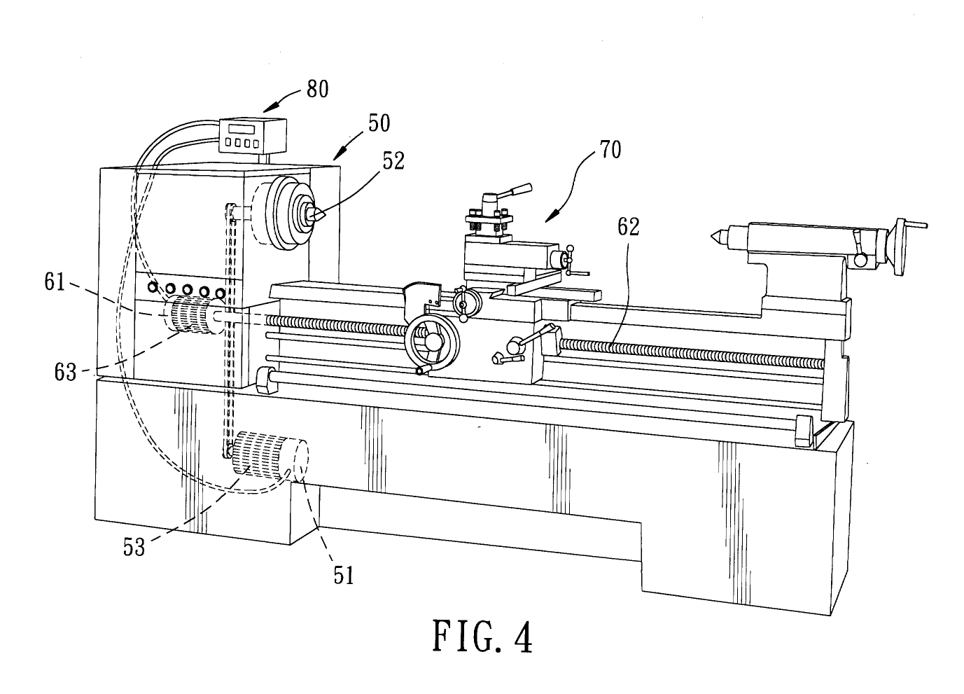

Referring to FIG. 4, an alternative embodiment of an electric motor-driven lathe according to the present invention is shown to be substantially similar to the previous embodiment in construction and operation. The major difference therebetween resides in that the first encoder 51 is mounted on the first servomotor 53 for driving the work spindle 52 that is mounted in a headstock 50, whereas the second encoder 61 is mounted on the second servomotor 63 that rotates the feed shaft 62 to drive the compound slide 70. The first and second encoders 51, 61 are coupled electrically to the controller 80.

With the aforesaid construction, synchronized rotation of the work spindle and the feed shaft can be achieved without the use of a gearbox, thereby resulting in a simpler construction and permitting relatively easy maintenance as compared with the prior art. In addition, due to the arrangement of the controller, the first and second encoders, and the first and second servomotors, the velocities of the work spindle and the feed shaft can be controlled individually to permit stepless thread cutting operation. That is, the velocity ratios of the work spindle and the feed shaft can be varied as desired to cut threads of different pitches.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An electrical motor-driven lathe, comprising:
a headstock;
a work spindle mounted in and rotatable relative to said headstock about a first axis, said work spindle being adapted for mounting a gripping member to hold a workpiece;
a guideway disposed to extend in a longitudinal direction parallel to the first axis;
a compound slide mounted to be movable along said guideway, and adapted to carry a tool holding post thereon;
a feed shaft mounted to be rotatable relative to said headstock about a second axis parallel to the first axis, and coupled to said compound slide to transmit a predetermined rotational force to said compound slide so as to move said compound slide along said guideway to a predetermined position;
a first servomotor disposed to drive said work spindle to rotate about the first axis at a predetermined velocity;
a second servomotor disposed to deliver said predetermined rotational force to said feed shaft, said second servomotor being independent of said first servomotor in mechanical drive; and
a controller disposed to control said first and second servomotors to drive said work spindle and to deliver said predetermined rotational force, respectively.

2. An electric motor-driven lathe according to claim 1, wherein said first servomotor is provided with a first output shaft to deliver a predetermined drive, and is disposed to have said first output shaft oriented in a line parallel to the first axis, said electric motor-driven lathe further comprising a transmission belt disposed to transmit said predetermined drive to said work spindle so as to drive said work spindle to rotate at the predetermined velocity.
